(19) United States
(12) Patent Application Publication
(10) Pub. No.: US 2006/0184717 A1
(43) Pub. Date: Aug. 17, 2006

(54) Integrated circuit capable of flash memory storage management

(75) Inventors: Michael A. Rothman, Puyallup, WA (US); Vincent J. Zimmer, Federal Way, WA (US)

Correspondence Address: Grossman, Tucker, Perreault & Pfleger, PLLC;c/o PortfolioIP, P.O. Box 52050, Minneapolis, MN, 55402, US

(73) Assignee: Intel Corporation

(21) Appl. No.: 11/059,768

(22) Filed: Feb. 17, 2005

(51) Int. Cl. G06F 12/00

(52) U.S. Cl. 711/103

(57) ABSTRACT

A method according to one embodiment may include creating a reserved portion on a storage device. The method of this embodiment may also include receiving at least one data write request to write data to a flash memory comprised in a host system. The method of this embodiment may also include redirecting the data write request to write the data to the reserved area of the storage device. Of course, many alternatives, variations, and modifications are possible without departing from this embodiment.

### FIELD

The present disclosure relates to an integrated circuit capable of flash memory storage management.

### BACKGROUND

One conventional computer system may include a host processor running one or more operating systems and applications and flash memory which stores system level information. In the conventional computer system, the host processor, operating system and application may attempt to write data to the flash memory top store operating system runtime variable, firmware variable or boot code information. However, the size of the flash memory is limited, and many resources may attempt to write to flash memory which may exceed the capacity of flash memory.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram illustrating a system embodiment;

FIG. 2A is a diagram illustrating an exemplary storage device according to the embodiment of FIG. 1;

FIG. 2B is a diagram illustrating an exemplary flash memory according to the embodiment of FIG. 1;

FIG. 3 is a diagram illustrating a platform management controller according to an embodiment;

FIG. 4 is a diagram illustrating another system embodiment;

FIG. 5 is a diagram illustrating exemplary operations according to one embodiment; and

FIG. 6 is a diagram illustrating exemplary operations according to another embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

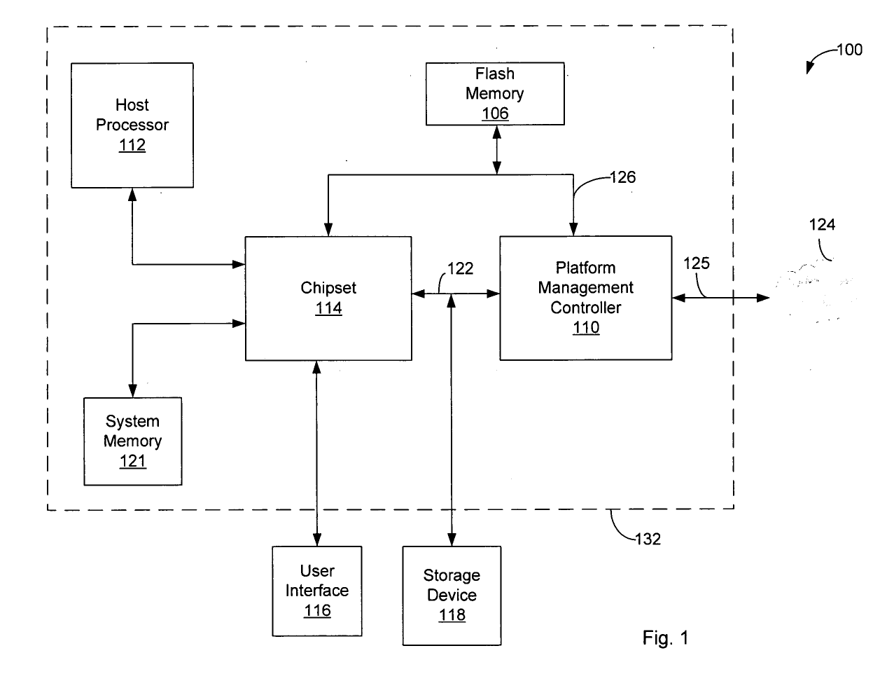

FIG. 1 illustrates a system embodiment 100 of the claimed subject matter. The system 100 may generally include a host processor 112, a first bus 122, a second bus 126, a user interface system 116, a chipset 114, system memory 121, platform management controller circuitry 110, and flash memory 106. This embodiment may also include a storage device 118. Storage device 118 may include, for example, a magnetic, optical and/or semiconductor media, for example, a hard disk device. The host processor 112 may include any variety of processors known in the art such as an Intel® Pentium® IV processor commercially available from the Assignee of the subject application. The buses 122, 126 may include various bus types to transfer data and commands. For instance, bus 122 may comply with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). The bus 126 may include comply with a Serial Peripheral Interface (SPI) Specification (hereinafter referred to as an “SPI bus”). Processor 112, system memory 121, chipset 114, buses 122 and 126, flash memory 106 and platform management controller circuitry 110 be comprised in a single circuit board, for example, motherboard 132, and these components collectively or individually may form a host system.

The user interface 116 may include a variety of devices for human users to input commands and/or data and to monitor the system such as a keyboard, pointing device, and video display. The chipset 114 may include host bridge/hub system (not shown) that couples the processor 112, system memory 121, user interface system 116, storage device 118, and platform management controller circuitry 110 to each other and to the bus 122. Chip set 114 may also be capable of coupling flash memory 106, host processor 112, system memory 121 and platform management controller circuitry 110 to each other and to bus 126. Chipset 114 may include integrated circuit chips, such as those selected from integrated circuit chipsets commercially available from the assignee of the subject application (e.g., graphics memory and I/O controller hub chipsets), although other integrated circuit chips may also, or alternatively be used.

System memory 121 may comprise one or more of the following types of memories: semiconductor firmware memory, programmable memory, non-volatile memory, read only memory, electrically programmable memory, random access memory, flash memory (which may include, for example, NAND or NOR type memory structures), magnetic disk memory, and/or optical disk memory. In this embodiment, memory 106 may comprise a flash memory. Either additionally or alternatively, memories 121 and/or 106 may comprise other and/or later-developed types of computer-readable memory. Machine-readable firmware program instructions may be stored in memories 121 and/or 106. As described below, these instructions may be accessed and executed by host processor 112 and/or platform management controller 110. When executed by host processor 112 and/or platform management controller 110, these instructions may result in host processor 112 and/or platform management controller 110 performing the operations described herein as being performed by host processor 112 and/or platform management controller 110.

Host processor 112 may be capable, among other things, of generating one or more input/output (I/O) transactions to read and/or write data to or from flash memory 106 and/or storage device 118. Host processor 112 may generate these I/O transactions in response to, for example, boot operations of the host system, operating system (OS) operations and/or applications (e.g., software applications executing one or more instructions on host processor 112 and/or firmware instructions) running on the host system. Alternatively or additionally, add-in devices (for example, add-in cards coupled to host system 132 (not shown)) and/or remote applications (not shown) may be capable of generating one or more input/output (I/O) transactions to read and/or write data to or from flash memory 106 and/or storage device 118.

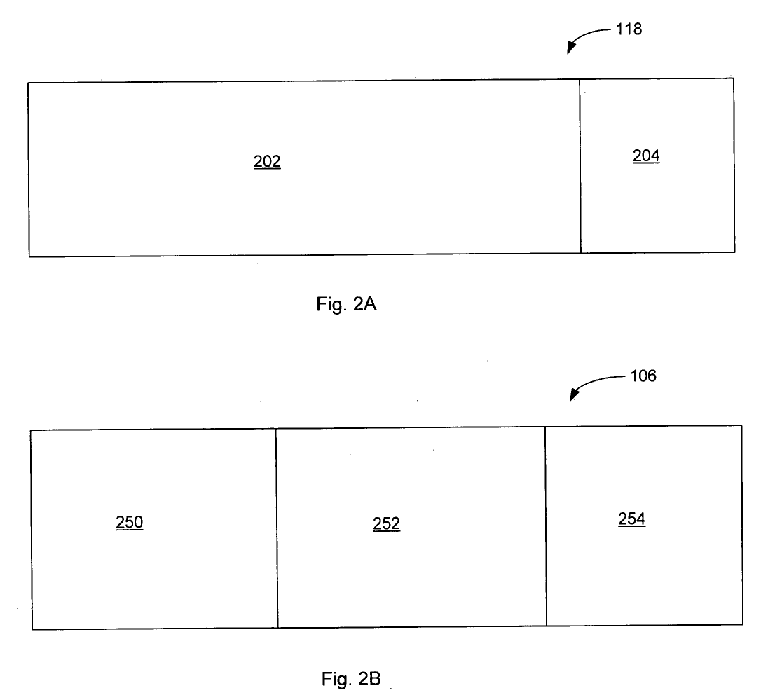

Flash memory 106 may be capable of storing boot code information, which may comprise, for example, built-in operating system (BIOS) data and/or firmware variables which may define one or more operating characteristics of one or more components of the host system depicted in the system 100 of FIG. 1 and/or application data executed by one or more components depicted in the system of FIG. 1. FIG. 2B depicts one exemplary embodiment of flash memory 106. In this exemplary embodiment, flash memory 106 may include a firmware boot block data portion 250, a main firmware image data portion 252 and a variable space data portion 254. Firmware boot block data portion 250 may be capable of storing instructions and/or data variables related to a boot procedure for host system 132. In other words, when host system 132 initializes (e.g., boots from a power off state or a system reset), processor 112 may be capable of reading and executing boot code information stored in boot block data portion 250 on flash memory 106, via chipset 114 and bus 126. Main firmware image portion 252 may include a copy of the data comprised in the boot block data portion 250, and may further include additional data used during post boot operations.

Variable space data portion 254 may comprise free space to which one or more resources may write data to. In this embodiment, resources may include, for example, the host processor 112, chipset 114 and/or one or more systems coupled to network 124. The type of data which may be written to variable space data portion 254 may comprise, for example, boot code data, application data, and/or operating system (OS) data. However, since many resources may be vying for the ability to write data to the variable space portion 254 of flash memory 106, and given the limited size of the variable space portion 254, flash memory 106 may not be able to support all of the data write attempts from the numerous resources associated with the system 100.

Accordingly, and referring again to the embodiment of FIG. 1, platform management controller circuitry 110 may be capable of controlling read and/or write access to flash memory 106, via bus 126, and/or storage device 118, via bus 122. Thus for example, in this embodiment, platform management controller circuitry 110 may be capable receiving a write request to write data to flash memory 106 and redirecting the data write operation to storage device 118. As used in any embodiment herein, “circuitry” may comprise, for example, singly or in any combination, hardwired circuitry, programmable circuitry, state machine circuitry, and/or firmware that stores instructions executed by programmable circuitry. Also, in any embodiment herein, circuitry 110 may be embodied as, and/or form part of, one or more integrated circuits. In this embodiment, platform management controller circuitry 110 may be capable of exchanging commands and data with flash memory 106 (via bus 126), chipset 114 and storage device 118 (via bus 122). Alternatively or additionally, platform management controller circuitry 110 may be capable of exchanging commands and data with flash memory 106 (via bus 126), chipset 114 and storage device 118 (via bus 122), and network 124 via network communications link 125. Network 124 may permit one or more remote systems and/or remote applications running on one or more remote systems (not shown) coupled to network 124 to exchange commands and data with platform management controller 110 to enable, for example, read and/or write access to flash memory 106.

Platform management controller circuitry 110 may also be capable of generating out-of-band (OOB) read and/or write operations to flash memory 106 and/or storage device 118. OOB read and/or write operations may comprise, for example read and/or write operations without specific instructions for same from host processor 112, chipset 114 and/or from operating system instructions or application instruction being executed on host system 132.

Platform management controller circuitry 110 may be capable of receiving an I/O transaction from host processor 112 (which may be in response to, for example, instructions from an application, OS, and/or firmware instructions being executed in chipset 114) to write data to the variable space data portion 254 of flash memory 106. If there is insufficient space in the variable space data portion 254 of flash memory 106 to write data thereto, platform management controller circuitry 110 may be capable of redirecting the data write transaction by generating an I/O transaction with storage device 118 to write the data to storage device 118. Alternatively or additionally, platform management controller circuitry 110 may be capable of receiving an I/O transaction from one or more remote systems, via network 124, to write data to the variable space data portion 254 of flash memory 106. If there is insufficient space in the variable space data portion 254 of flash memory 106 to write data thereto, platform management controller circuitry 110 may be capable of redirecting the data write transaction by generating an I/O transaction with storage device 118 to write the data to storage device 118.

FIG. 2A depicts one exemplary storage device 118 according to an embodiment. Storage device 118 may include a data portion 202 and a reserved portion 204. The data portion 202 may be accessed by host processor 112 to read and/or write data thereon, and may generally be accessible to host processor 112 and OS runtime applications. In this embodiment, platform management controller circuitry 110 may be capable of controlling storage device 118 to create the reserved portion 204. Depending on the media type of storage device 118, the size of reserved portion 204 may be defined by, for example, a selected LBA address range. Platform management controller circuitry 110 may also be capable of concealing reserved portion 204 from being accessed by other circuitry, for example, concealing reserved portion 204 from host processor 112 and/or chipset 114 and/or one or more systems coupled to network 124 to prevent host processor 112 and/or chipset 114 and/or one or more systems coupled to network 124 from accessing the reserved portion 204 of the storage device 118. In this embodiment, if there is insufficient space in the variable space data portion 252 of flash memory 106 to write data thereto (in response, for example, to a data write request from host processor 112), platform management controller circuitry 110 may be capable of redirecting the data write transaction by generating an I/O transaction with storage device 118 to write the data to the reserved portion 204 of storage device 118.

Since data written by platform management controller circuitry 110 to storage device 118 may be used during boot operations and/or OS runtime operations (which may comprise, for example, operating system application and/or instructions being executed by host processor 112 and/or chipset 114), platform management controller circuitry 110 may further be capable of updating flash memory 106 with one or more instructions indicating that boot data and/or OS runtime data is stored on storage device 118. Thus, during boot operations and/or OS runtime operations, in response to an I/O transaction request from host processor 112, chipset 114 and/or from one or more remote systems via network 124, platform management controller circuitry 110 may be capable of reading data from storage device 118 which may include, for example, reading from reserved portion 204.

Platform management controller circuitry 110 may also be capable of arbitrating read and/or write access of storage device 118 to protect reserved portion 204 from being accessed. Thus, for example, if host processor 112 generates an I/O transaction to read or write data to storage device 118, platform management controller circuitry 110 may receive this request (via bus 120), and deny the read and/or write request if the data is stored on (or is to be written to) the reserved portion 204 of storage device 118 and/or grant the read and/or write request if the data is stored on (or is to be written to) the data portion 202 of storage device 118.

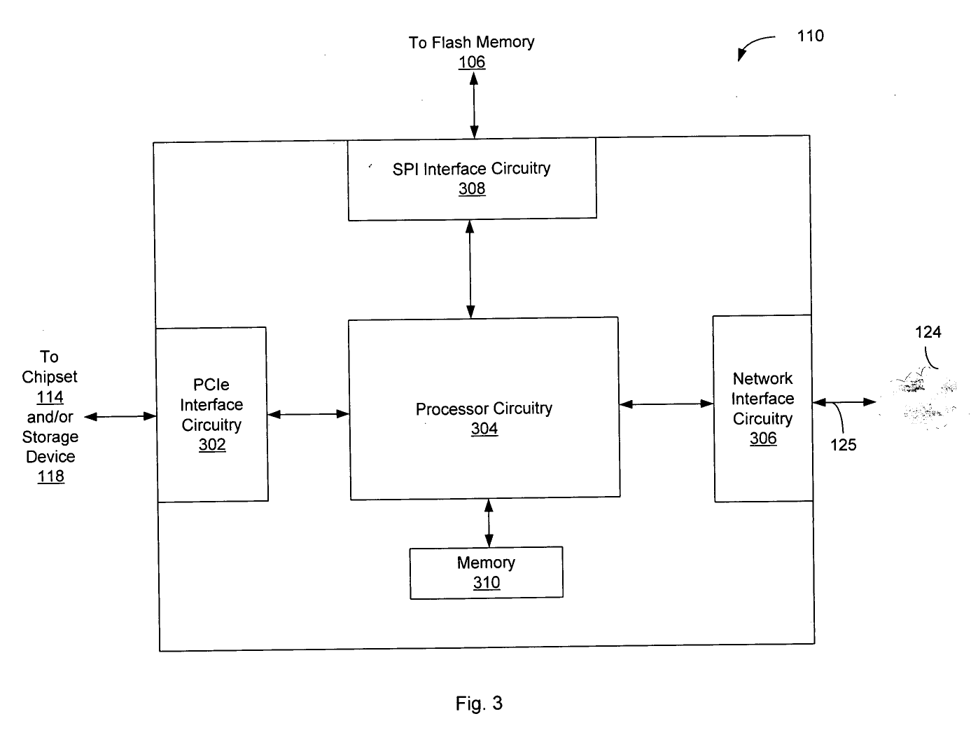

FIG. 3 depicts exemplary platform management controller circuitry 110. In FIG. 3, certain portions of the system 100 depicted in FIG. 1 have been omitted for clarity (for example circuit board 132), but it is to be understood that like parts of FIG. 3 can be implemented in a manner consistent with an embodiment depicted in FIG. 1, or alternatively in other system implementations, without departing from this embodiment. Circuitry 110 may include controller circuitry 304 which may be capable of performing operations described herein as being attributed to platform circuitry 110. Controller circuitry 304 may comprise respective circuitry that may be compatible and/or in compliance with the Intel® XScale™ Core micro-architecture described in “Intel® XScale™ Core Developers Manual,” published December 2000 by the Assignee of the subject application. Of course, controller circuitry 304 may comprise other types of processor core circuitry without departing from this embodiment. Circuitry 110 may also comprise memory 310. Memory 310 may comprise, for example, computer-readable program instruction memory that may contain respective sets of micro-code program instructions that controller circuitry 304 may execute. The execution of these respective sets of program instructions by controller circuitry 304 may result in the carrying out of operations described herein as being carried out by controller circuitry 304.

Memory 310 may comprise one or more platform policy instructions, which may define a rule or set of rules which may dictate for example, the management of storage device 118 and policy rules for read and/or write access to flash memory 106. Exemplary platform policy instructions may include the size of the reserved portion 204, enabling or disabling concealment of reserved portion 204, enabling and/or disabling read and/or write access to flash memory 106, priority rules associated with data write and/or read transactions to flash memory 106, and/or other platform policy instructions. Controller circuitry 304 may execute platform policy instructions during operation of platform management controller circuitry 110. Of course, these are only exemplary instructions and other platform policy instructions are equally contemplated herein.

In this embodiment, circuitry 110 may also include PCIe interface circuitry 302 which may permit controller circuitry 304 to exchange commands and data with chipset 114 and/or storage device 118 via PCIe bus 122. Circuitry 110 may also include SPI interface circuitry 308 which may permit controller circuitry 304 to exchange commands and data with flash memory 106 via SPI bus 126. However, other bus technology and bus corresponding bus interface circuitry is equally contemplated by this embodiment. Circuitry 110 may further include network interface circuitry 306 which may permit controller circuitry 304 to exchange commands and data with one or more remote systems via network 124 and communications link 125. Network 124 may comply or be compatible with transmission communication protocol/internet protocol (TCP/IP) communication protocols, however, other communication protocols are equally contemplated by this embodiment.

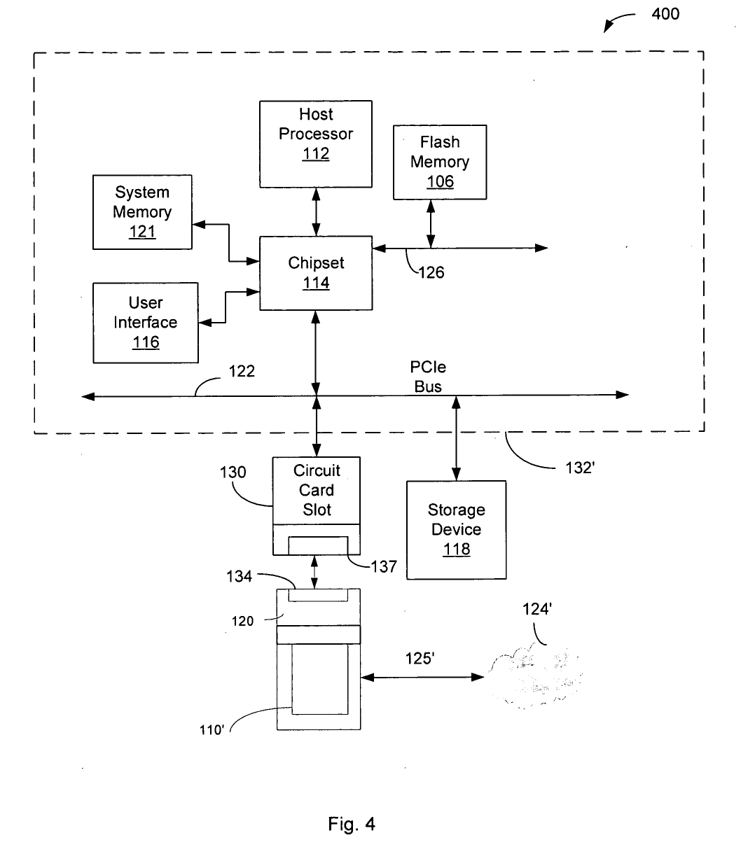

FIG. 4 illustrates another system embodiment 400 of the claimed subject matter. In this embodiment, platform management controller circuitry 110′ may be comprised in a circuit card 120 which may be coupled to bus 122. As with the embodiment of FIG. 1, platform management controller circuitry 110′ may be comprised in, or form part of, one or more integrated circuit chips. This embodiment may include a circuit card slot 130. The circuit card 120 may be constructed to permit it to be inserted into slot 130. When the circuit card 120 is properly inserted into slot 130, connectors 134 and 137 may become electrically and mechanically coupled to each other. When connectors 134 and 137 are so coupled to each other, the card 120 may become electrically coupled to bus 122 and may exchange data and/or commands with system memory 121, host processor 112, user interface system 116 and/or flash memory 106 via bus 122 and/or bus 126 and chipset 114. Alternatively or additionally, platform management controller circuitry 110′ may exchange commands and data with host system 132′ and one or more remote systems coupled to network 124′, via communications link 125′. The operation of platform management circuitry 110 in this embodiment may be identical to the operation described above with reference to FIGS. 1-3, except that SPI bus interface circuitry 308 may be omitted and instead commands and data may be exchanged between circuit card 120 and flash memory 106 via chipset 114.

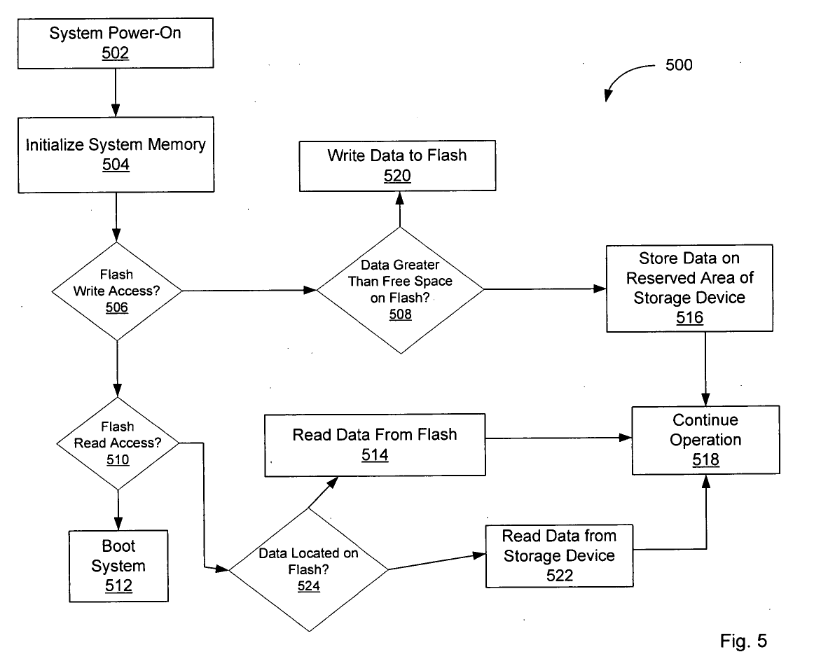

FIG. 5 is a flowchart 500 illustrating exemplary operations that may be performed according to an embodiment. Operations may include system power on operations 502, which may comprise, for example, power on of a host processor, system memory and chipset, and may also include initializing system memory 504. Operations may further include determining if write access to flash memory is enabled 506. If write access is enabled, operations may include determining if the size of the data corresponding to a write request to flash memory is greater than the free space on flash memory 508. If not, then operations may include writing data to flash memory 520. If the size of the data corresponding to a write request to flash memory is greater than the free space on flash memory, operations may further include storing the data on a reserved area of a storage device 516, and continuing operations 518. If flash memory write access is not enabled, operations may further include determining if flash memory read access is enabled 510. If enabled, operation may include determining if the data associated with the read request is located on flash memory 524. If the data associated with the read request is located on flash memory, operations may include reading the data from flash memory 514, and operations may continue 518. If the data associated with the read request is not located on flash memory, operations may include reading the data from a storage device 522. If read access is not enabled, operations may include completing system boot operations 512.

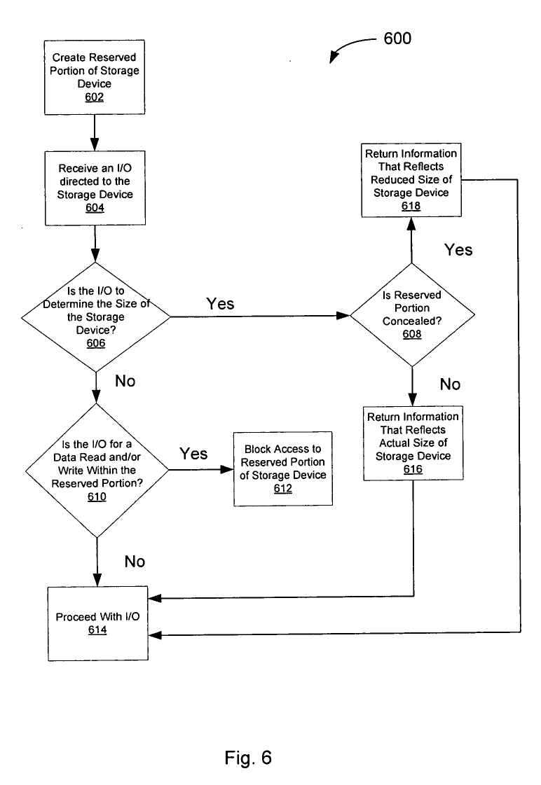

FIG. 6 is a flowchart illustrating exemplary operations 600 that may be performed according to another embodiment. Operations may include creating a reserved portion of a storage device 602. Operations may further include receiving an I/O directed to the storage device 604. Operations may also include determining if the I/O is to determine the size of the storage device 606. If so, operations may include determining if the reserved portion of the storage device is concealed 608. If so, operations may include returning information that reflect the reduced size of the storage device 618, and proceeding with the I/O 614. Reduced size may comprise for example, the actual size of the storage device minus the reserved portion of the storage device. If not, operations may include returning information that reflects the actual size of the storage device 616, and proceeding with the I/O 614. Operations may also include determining if the I/O is for a data read and/or data write within the reserved portion 610. If yes, operations may include blocking access to the reserved portion of the storage device 612. If not, operations may also include proceeding with the I/O 614.

Thus, in summary, at least one embodiment herein may provide an integrated circuit capable of creating a reserved portion on a storage device. The integrated circuit of this embodiment may be further capable of receiving at least one data write request to write data to a flash memory comprised in a host system and redirecting said data write request to write the data to the reserved portion of the storage device.

Advantageously, the integrated circuit of this embodiment may reduce cost by permitting a smaller flash memory to be used. Further advantageously, the integrated circuit of this embodiment may permit storing of event logs and data on the reserved portion of the storage device which may be used for system audits. Further advantageously, the integrated circuit of this embodiment may be able to store data in a secure (concealed) reserved portion of the storage device which may be inaccessible to operating system and/or chipset read/write operations. Also, the integrated circuit of this embodiment may be capable of saving critical file system structures to the reserved portion of the storage device to permit, for example, recovery of broken boot structures which may result from virus or flash memory failure.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. An apparatus, comprising:
an integrated circuit capable of creating a reserved portion on a storage device, said integrated circuit is further capable of receiving at least one data write request to write data to a flash memory comprised in a host system and redirecting said data write request to write the data to said reserved portion of said storage device.

2. The apparatus of claim 1, wherein:
said integrated circuit is further capable of receiving at least one data read request to read said flash memory and redirecting said data read request to said reserved area of said storage device.

3. The apparatus of claim 1, wherein:
said integrated circuit is further capable of concealing said reserved area of said storage device from a host processor coupled to said host system.

4. The apparatus of claim 1, wherein:
said flash memory comprises boot code information and a variable space portion, said integrated circuit is further capable of determining the size of said variable space portion and writing said data to said reserved area of said storage device if said variable space portion of said flash memory is insufficient to store said data.

5. The apparatus of claim 1, wherein:
said integrated circuit is further capable of preventing read and/or write access to said reserved portion of said storage device.

6. A system, comprising:
at least one circuit card being capable of being coupled to a bus, said circuit card comprising an integrated circuit capable of creating a reserved portion on a storage device coupled to said bus, said integrated circuit is further capable of receiving at least one data write request to write data to a flash memory coupled to said bus and redirecting the data write request to write the data to said reserved portion of said storage device.

7. The system of claim 6, wherein:
said integrated circuit is further capable of receiving at least one data read request to read said flash memory and redirecting said data read request to said reserved portion of said storage device.

8. The system of claim 6, wherein:
said integrated circuit is further capable of concealing said reserved area of said storage device from a host processor coupled to said bus.

9. The system of claim 6, wherein:
said flash memory comprises boot code information and a variable space portion, said integrated circuit is further capable of determining the size of said variable space portion and writing said data to said reserved area of said storage device if said variable space portion of said flash memory is insufficient to store said data.

10. The system of claim 6, wherein:
said integrated circuit is further capable of preventing read and/or write access to said reserved portion of said storage device.

11. An article comprising:
a storage medium having stored thereon instructions that when executed by a machine result in the following operations:
creating a reserved portion on a storage device;
receiving at least one data write request to write data to a flash memory comprised in a host system; and
redirecting the data write request to write the data to said reserved area of said storage device.

12. The article of claim 11, wherein said instructions that when executed by said machine result in the following additional operations:
receiving at least one data read request to read said flash memory; and
redirecting said data read request to said reserved portion of said storage device.

13. The article of claim 11, wherein said instructions that when executed by said machine result in the following additional operations:
concealing said reserved portion of said storage device from a host processor coupled to said host system.

14. The article of claim 11, wherein:
said flash memory comprises boot code information and a variable space portion, and wherein said instructions that when executed by said machine result in the following additional operations:
determining the size of said variable space portion; and
writing said data to said reserved portion of said storage device if said variable space portion of said flash memory is insufficient to store said data.

15. The article of claim 11, wherein said instructions that when executed by said machine result in the following additional operations:
preventing read and/or write access to said reserved portion of said storage device.

16. A method, comprising:
creating a reserved portion on a storage device;
receiving at least one data write request to write data to a flash memory comprised in a host system; and
redirecting the data write request to write the data to said reserved area of said storage device.

17. The method of claim 16, further comprising:
receiving at least one data read request to read said flash memory; and
redirecting said data read request to said reserved portion of said storage device.

18. The method of claim 16, further comprising:
concealing said reserved portion of said storage device from a host processor coupled to said host system.

19. The method of claim 16, wherein:
said flash memory comprises boot code information and a variable space portion, and wherein said method further comprising:
determining the size of said variable space portion; and
writing said data to said reserved portion of said storage device if said variable space portion of said flash memory is insufficient to store said data.

20. The method of claim 16, further comprising: preventing read and/or write access to said reserved portion of said storage device.
